(19) United States
(12) Patent Application Publication
(10) Pub. No.: US 2025/0385021 A1
(43) Pub. Date: Dec. 18, 2025

(54) INTEGRATED ATOMIC SOURCE DEVICE

(71) Applicant: Quantinuum LLC, Broomfield, CO (US)

(72) Inventors: Adam Jay OLLANIK, Boulder, CO (US); Justin Thomas SCHULTZ, Westminster, CO (US); Johanna ZULTAK, Broomfield, CO (US)

(21) Appl. No.: 19/240,545

(22) Filed: Jun. 17, 2025

Related U.S. Application Data
(60) Provisional application No. 63/661,154, filed on Jun. 18, 2024.

(51) Int. Cl. G21K 1/00

(52) U.S. Cl. CPC G21K 1/003; G21K 1/006

(57) ABSTRACT

Atomic confinement apparatuses, systems comprising atomic confinement apparatuses, and methods for fabricating atomic confinement apparatuses are provided. An atomic confinement apparatus may comprise one or more integrated atomic source devices. The one or more integrated atomic source devices may comprise a source assembly comprising a heater element and deposited atomic source material, an object storage assembly, and a coupling assembly.

### CROSS-REFERENCE TO RELATED APPLICATION(S)

This application claims priority to U.S. Application No. 63/661,154, filed Jun. 18, 2024, the contents of which are incorporated herein by reference in their entireties.

### TECHNICAL FIELD

Various embodiments relate to atomic source devices configured to be integrated with atomic confinement apparatuses, atomic confinement apparatuses including integrated atomic source devices, and methods for fabricating integrated atomic source devices.

### BACKGROUND

Atomic confinement apparatuses are used to confine or trap atomic objects, such as atoms, ions, molecules, and/or the like. For atomic systems contained within vacuum chambers, using large atomic ovens within secondary vacuum chambers for providing atomic objects to the atomic system may risk compromising the vacuum. Additionally, such large atomic ovens may add a substantial amount of heat to the atomic system and therefore are generally located some distance away from the atomic system. Various techniques, such as incorporating magneto-optical traps (MOTs) may be used to aid in the transport of the atomic objects from the oven to the atomic system. However, such additional systems may further compromise the vacuum chamber and add complexity to the system. Through applied effort, ingenuity, and innovation many deficiencies of such atomic object sources and providing atomic objects to confinement apparatuses and methods of fabrication thereof have been solved by developing solutions that are structured in accordance with the embodiments of the present invention, many examples of which are described in detail herein.

### BRIEF SUMMARY OF EXAMPLE EMBODIMENTS

Example embodiments provide atomic source devices configured to be integrated with atomic confinement apparatuses, atomic confinement apparatuses including atomic source devices, systems comprising atomic confinement apparatuses, and methods for fabricating atomic source devices and atomic confinement apparatuses including atomic source devices. In various embodiments, an atomic confinement apparatus comprises one or more integrated atomic source devices. An integrated atomic source device is configured to provide atomic objects to the atomic confinement apparatus. In various embodiments, the one or more integrated atomic source devices comprise a source assembly comprising a heater element and deposited atomic source material, an object storage assembly, and a coupling assembly.

According to an aspect of the present disclosure, an atomic source device is provided. The atomic source device may comprise a source assembly comprising a source component and deposited atomic source material; an object storage assembly configured to receive objects emitted by the source assembly and confine them or maintain them within a defined volume; and a coupling assembly configured to receive objects from the storage assembly and couple them into a confinement region of a confinement apparatus.

In some embodiments, the source component is comprised of a suspended membrane coupled to legs configured to thermally isolate the source component and the deposited atomic source material from at least a portion of the atomic source device.

In some embodiments, the object storage assembly is configured to be reloaded before it becomes empty such that it stores a constant supply of objects.

In some embodiments, the object storage assembly comprises at least one of a three-dimensional (3D) or a two-dimensional (2D) ion trap.

In some embodiments, the object storage assembly further comprises one or more optical components configured to provide an ionizing beam configured for ionizing objects emitted by the source assembly and received into the defined volume.

In some embodiments, objects emitted by the source assembly are ionized upon emission from the source assembly.

In some embodiments, the source component is configured to heat the deposited atomic source material to cause the objects to be release therefrom.

In some embodiments, the coupling assembly comprises a two-dimensional ion trap.

In some embodiments, the confinement apparatus is a trapped-ion quantum computer.

According to an aspect of the present disclosure, a confinement apparatus assembly is provided. The confinement apparatus assembly may comprise a confinement apparatus configured to generate at least one confinement regions; and at least one atomic source device, the at least one atomic source device comprising at least one source assembly comprising a source component and some deposited atomic source material, the at least one atomic source device configured to provide atomic objects from the deposited atomic source material to the at least one confinement region.

In some embodiments, the at least one atomic source device further comprises at least one of: an object storage assembly configured to receive objects emitted by the source assembly and confine them or maintain them within a defined volume; or a coupling assembly configured to receive objects provided by the source assembly and couple them into the at least one confinement region.

In some embodiments, radiofrequency (RF) electrodes are configured to generate a tube-shaped potential well, direct current (DC) electrodes are configured to cap ends of the tube-shaped potential, and the DC electrodes are further configured to move atomic objects along the length of the tube-shaped potential.

In some embodiments, the object storage assembly comprises horizontal RF electrodes, and the object storage assembly is aligned with the coupling assembly via a taper junction.

In some embodiments, the object storage assembly comprises diagonal RF electrodes, and the object storage assembly is aligned with the coupling assembly via a taper junction.

In some embodiments, the object storage assembly comprises horizontal RF electrodes, and wherein the object storage assembly is aligned with the coupling assembly via butt-coupling.

In some embodiments, the object storage assembly comprises diagonal RF electrodes, and wherein the object storage assembly is aligned with the coupling assembly via butt-coupling.

In some embodiments, the object storage assembly comprises horizontal RF electrodes, and wherein the object storage assembly is aligned with the coupling assembly via a chip-to-chip hurdle.

In some embodiments, the object storage assembly comprises diagonal RF electrodes, and wherein the object storage assembly is aligned with the coupling assembly via a chip-to-chip hurdle.

In some embodiments, the at least one atomic source device comprises two or more atomic source devices.

In some embodiments, the two or more atomic source devices comprise source assemblies corresponding to different species of atoms.

According to an aspect of the present disclosure, a method is provided. The method may comprise: fabricating a membrane-substrate package comprising a thin material film disposed on a substrate; forming a source component on a first surface of the membrane of the membrane-substrate package; removing the substrate from a second surface of the membrane, the second surface being opposite the first surface; and depositing atomic source material on the second surface of the membrane.

In some embodiments, the method further comprises covering the atomic source material with a passivation layer.

In some embodiments, at least one of the membrane-substrate package or the heater element is fabricated via lithography.

In some embodiments, the membrane-substrate package is comprised of at least one of: silicon on insulator (SOI); silicon and silicon dioxide (Si/SiO2); silicon nitride and silicon (SiN/Si); or silicon nitride and silicon dioxide (SiN/SiO2).

In some embodiments, the membrane is less than 10 microns in thickness.

In some embodiments, the source component is an electrical resistive heater comprised of at least one of: gold (Au); tungsten (W); molybdenum (Mo); or molybdenum compounds.

In some embodiments, the source component is comprised of an optically absorptive material and the source component is configured to heat the deposited atomic source material responsive to absorbing optical power.

In some embodiments, the optically absorptive material is silicon (Si).

In some embodiments, the source component is defined via optical lithography.

In some embodiments, the method further comprises heating the atomic source material and the passivation layer using the source component to remove the passivation layer.

According to an aspect of the present disclosure, a method is provided. The method may comprise aligning a source assembly to a storage assembly or a coupling assembly; and aligning the storage assembly to the coupling assembly.

In some embodiments, the aligning the source assembly to the storage assembly or the coupling assembly comprises bonding the source assembly to the storage assembly or the coupling assembly.

In some embodiments, the coupling assembly is comprised in a trapped-ion quantum computer.

In some embodiments, aligning the storage assembly to the coupling assembly further comprises aligning the storage assembly to a platform coupled to the coupling assembly.

In some embodiments, the method further comprises mounting the storage assembly to a dynamic platform that allows the storage assembly to be aligned with the coupling assembly.

In some embodiments, the dynamic platform is a piezo-stage.

In some embodiments, the coupling assembly comprises two or more coupling assemblies.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a block diagram of an example system comprising an atomic confinement apparatus, in accordance with an example embodiment.

FIG. 2 provides a perspective view of an example integrated atomic source device, in accordance with an example embodiment.

FIG. 3 provides a cross-sectional view of an example integrated atomic source device, in accordance with an example embodiment.

FIG. 4A provides a perspective view of an example source assembly comprising at least a heater element and deposited atomic source material, in accordance with an example embodiment.

FIG. 4B provides a perspective view of an example heater element, in accordance with an example embodiment.

FIG. 4C provides top views of various example heater element configurations, in accordance with an example embodiment.

FIG. 4D provides a cross-sectional view of an example source assembly comprising at least a heater element and deposited atomic source material, in accordance with an example embodiment.

FIG. 5A provides a perspective view of an example object storage assembly, in accordance with an example embodiment.

FIG. 5B provides a cross-sectional view of an example object storage assembly, in accordance with an example embodiment.

FIG. 6A provides a perspective view of an example coupling assembly, in accordance with an example embodiment.

FIG. 6B provides a cross-sectional view of an example coupling assembly, in accordance with an example embodiment.

FIG. 6C provides a top view of at least a portion of an example atomic confinement apparatus, in accordance with an example embodiment.

FIG. 7A provides a perspective view of an example integrated atomic source device comprising diagonal radiofrequency (RF) electrodes, in accordance with an example embodiment.

FIG. 7B provides a perspective view of an example integrated atomic source device comprising tapered horizontal RF electrodes, in accordance with an example embodiment.

FIG. 8A provides a perspective view of an example atomic confinement apparatus configuration comprising hurdle butt-coupling, in accordance with an example embodiment.

FIG. 8B provides a top view of an example atomic confinement apparatus configuration comprising hurdle butt-coupling, in accordance with an example embodiment.

FIG. 9A provides a perspective view of an example atomic confinement apparatus configuration comprising chip-to-chip butt coupling, in accordance with an example embodiment.

FIG. 9B provides a top view of an example atomic confinement apparatus configuration comprising chip-to-chip butt coupling, in accordance with an example embodiment.

FIG. 10 provides a top view of an example atomic confinement apparatus configuration comprising a tapered handoff, in accordance with an example embodiment.

FIG. 11 provides a diagram visualizing example atomic confinement apparatus configurations, in accordance with an example embodiment.

FIG. 12 provides a cross-sectional view of an example method for fabricating a source assembly, in accordance with an example embodiment.

FIG. 13 provides a flowchart of an example method for fabricating an integrated atomic source device, in accordance with an example embodiment.

FIG. 14 provides a schematic diagram of an example controller of a system comprising a quantum object confinement apparatus configured for confining atomic objects therein, in accordance with an example embodiment.

FIG. 15 provides a schematic diagram of an example computing entity of a system comprising a quantum object confinement apparatus that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, atomic objects are confined by an atomic confinement apparatus. In various embodiments, an atomic object is an ion; atom; ionic, molecular, and/or multipolar molecule; and/or other quantum particle. In an example embodiment where the atomic objects are ions, the confinement apparatus is an ion trap, such as a surface ion trap, Paul ion trap, and/or the like. In an example embodiment, the confinement apparatus is configured to confine atomic objects of multiple species (e.g., ions of different species and/or different atomic numbers) and to form mixed-species object groups or crystals.

In various other embodiments, the confinement apparatus is an apparatus configured to confine atomic objects and comprises a plurality of surface electrodes. For example, in various embodiments, the confinement apparatus comprises a substrate that may include one or more layers including one or more vias, metal routing and/or interconnect layers, photonic/optical layers, and/or the like. A plurality of surface electrodes is formed on the substrate.

In various embodiments, the atomic objects confined by a confinement apparatus are used to perform experiments, controlled quantum state evolution, quantum computations, and/or the like. For example, the confinement apparatus may be part of an atomic system, such as an atomic clock, spectroscopic and/or mass analyzer system, quantum charge-coupled device (QCCD)-based quantum computer, and/or the like.

Some conventional trapped ion quantum computers (e.g., QCCD-based quantum computers) use confinement apparatuses disposed within vacuum chambers and are maintained at cryogenic temperatures such that the vacuum chamber is also a cryostat. Some conventional assemblies for providing ions to the confinement apparatus include sublimating an atomic source in an oven that is located a distance (e.g., approximately 0.5 meters) from the confinement apparatus and directing at least some of the atomic flux through a loading hole formed through the confinement apparatus. In some conventional assemblies, the oven must be maintained a distance away from the confinement apparatus because of the large amount of heat generated when the oven is in use and the higher pressure created by the oven when it is running at high flux. As such, a significant amount of the atomic flux generated by the oven is not captured by the confinement apparatus and leads to additional background objects within the vacuum chamber. Moreover, fabrication of load holes through the confinement apparatus to allow the atomic flux to pass through the substrate hosting the confinement apparatus is technically complex.

Embodiments of the present disclosure provide technical solutions to these technical problems. Various embodiments provide confinement apparatuses, systems comprising confinement apparatuses, and/or methods for fabricating confinement apparatuses that comprise integrated atomic source devices. Various embodiments provide confinement apparatuses, systems comprising confinement apparatuses, and/or methods for fabricating confinement apparatuses that comprise miniature integrated atomic source devices.

In various embodiments, the integrated atomic source devices take the form of small chips. In various embodiments, the integrated atomic source devices are coupled to the confinement apparatus without compromising the vacuum, without adding large heat loads, and/or without requiring the fabrication of load holes through the substrate hosting the confinement apparatus.

Thus, various embodiments provide atomic source devices configured to be coupled to confinement apparatuses and/or confinement apparatuses having integrated atomic source devices (e.g., integrated ion sources). Various embodiments provide systems that include such confinement apparatuses and various embodiments provide methods for fabricating such confinement apparatuses. Various embodiments therefore provide an improvement to the field of confinement apparatuses, systems including confinement apparatuses, and methods for fabricating confinement apparatuses.

### Exemplary System Comprising an Atomic Confinement Apparatus

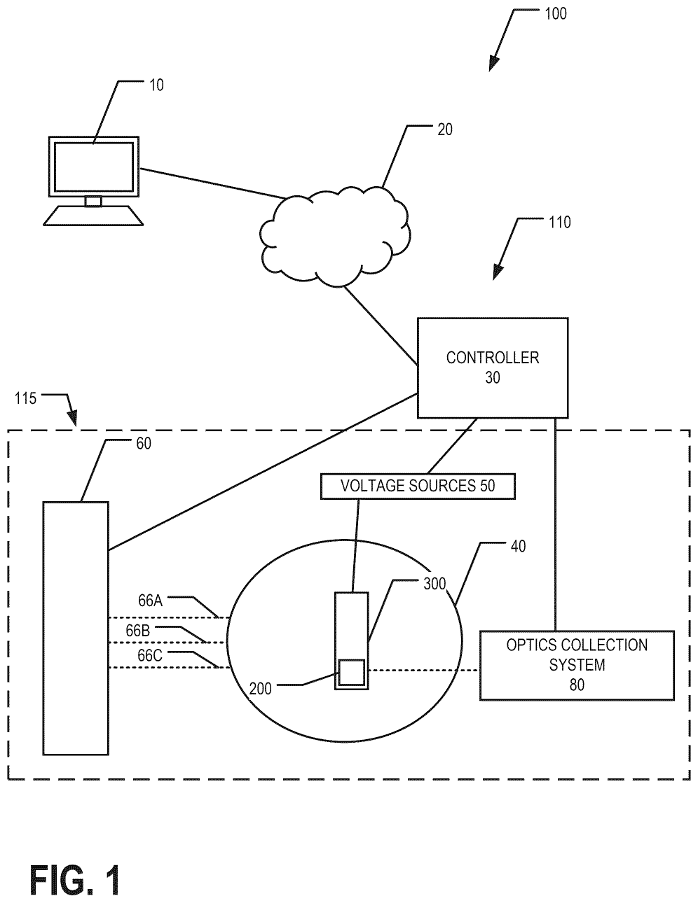

As noted above, various confinement apparatuses of various embodiments may be incorporated into various atomic systems, quantum systems, and/or the like. For example, various embodiments provide a system 100 comprising an atomic confinement apparatus 300, as shown in FIG. 1. The atomic confinement apparatus 300 is configured to confine a plurality of atomic objects such that the respective quantum states of the atomic objects may be manipulated, evolved in a controlled manner (e.g., in accordance with a quantum circuit), and/or the like. The atomic confinement apparatus, in various embodiments, comprises an integrated atomic source device 200.

For example, atomic objects may be used as the qubits of a quantum computer 110. For example, quantum operations (one qubit quantum logic gates, two qubit quantum logic gates, initialization, reading/detecting operations, and/or the like) may be performed on atomic objects confined by the confinement apparatus 300 and/or system 100 comprising the confinement apparatus 300. For example, the confinement apparatus 300 is configured to maintain one or more atomic objects at respective locations and/or transport atomic objects between respective locations such that the quantum operation may be performed on the one or more atomic objects.

In various embodiments, the system 100 comprising the confinement apparatus 300 comprises one or more manipulation sources 60 configured to provide manipulation signals (e.g., laser beams and/or pulses, microwave signals/fields, and/or the like) such that the manipulation signals interact with one or more atomic objects confined at particular locations defined at least in part by the confinement apparatus. In various embodiments, the system 100 comprising the confinement apparatus 300 comprises one or more magnetic field sources (not shown) configured to provide a controlled magnetic field and/or magnetic field gradient at particular locations defined at least in part by the confinement apparatus for use in performing one or more quantum operations on one or more atomic objects confined by the confinement apparatus 300. In various embodiments, the system 100 comprising the confinement apparatus 300 comprises an optics collection system configured to collect and/or detect light and/or photons emitted by one or more atomic objects disposed at the particular locations defined at least in part by the confinement apparatus.

In an example embodiment, the system 100 comprising the confinement apparatus 300 is and/or includes a quantum charge-coupled device (QCCD)-based quantum computer 110. For example, one or more of the atomic objects confined by the confinement apparatus 300 may be used as qubits of the quantum computer 110.

In various embodiments, the system 100 comprises a classical and/or semiconductor-based computing entity 10 and a quantum computer 110. In various embodiments, the quantum computer 110 comprises a controller 30 and a quantum processor 115. In various embodiments, the quantum processor 115 comprises a cryostat and/or vacuum chamber 40 enclosing a confinement apparatus 300, one or more manipulation sources 60 one or more voltage sources 50, one or more magnetic field sources, an optics collection system 80, and/or the like. In various embodiments, the optics collection system 80 comprises one or more photodetectors. In various embodiments, the controller 30 is configured to control the operation of (e.g., control one or more drivers configured to cause operation of) the manipulation sources 60, voltage sources 50, magnetic field sources, a vacuum system and/or cryogenic cooling system (not shown), and/or the like. In various embodiments, the controller 30 is configured to receive signals (e.g., electrical signals) generated and provided by the optics collection system 80.

In an example embodiment, the one or more manipulation sources 60 may comprise one or more lasers (e.g., optical lasers, microwave sources and/or masers, and/or the like) or another manipulation source. In various embodiments, the one or more manipulation sources 60 are configured to manipulate and/or cause a controlled quantum state evolution of one or more atomic objects confined by the confinement apparatus 300. For example, a first manipulation source 60 is configured to generate and/or provide a manipulation signal that is used to ionize neutral atomic objects. Various manipulation sources are configured to generate and provide manipulation signals configured to perform one or more quantum operations (single qubit gates, two-qubit gates, cooling, initialization, reading/detection, and/or like) on atomic objects confined by the confinement apparatus.

In an example embodiment, the one or more manipulation sources 60 each provide a manipulation signal (e.g., laser beam and/or the like) to one or more regions of the atomic confinement apparatus 300 via corresponding beam path systems 66 (e.g., 66A, 66B, 66C). In various embodiments, at least one beam path system 66 comprises a modulator configured to modulate the manipulation signal being provided to the confinement apparatus 300 via the beam path system 66. In various embodiments, a beam path system 66 includes one or more photonic elements (e.g., waveguides, beam splitters, grating couplers, modulators, polarizers, etc.) integrated on the same substrate as the confinement apparatus and/or a photonic integrated circuit (PIC) disposed within the cryostat and/or vacuum chamber 40. In an example embodiment, a beam path system 66 includes one or more optical fibers configured to transport manipulation signals at least partially from a manipulation source 60 to a PIC formed on the same substrate as the confinement apparatus and/or another substrate configured to be secured with respect to the confinement apparatus (e.g., packaged with the substrate housing the confinement apparatus). In an example embodiment, one or more of the manipulation sources 60 are disposed within the cryostat and/or vacuum chamber 40 (e.g., on the same substrate as the confinement apparatus and/or another substrate configured to be secured with respect to the confinement apparatus). In various embodiments, the manipulation sources 60, modulator, and/or other components of the quantum computer 110 are controlled by the controller 30.

In various embodiments, the confinement apparatus 300 is an ion trap, such as a surface ion trap, Paul ion trap, and/or the like. In various embodiments, the atomic objects are ions; atoms; ion crystals and/or groups; atomic crystals and/or groups; charged, neutral, and/or multipolar molecules; and/or quantum particles. In various embodiments, the confinement apparatus 300 is configured to confine various species of atomic objects and may form multi-species object groups or crystals. In various embodiments, the confinement apparatus 300 is an appropriate confinement apparatus for confining the atomic objects of the embodiment.

In various embodiments, the quantum computer 110 comprises one or more voltage sources 50. For example, the voltage sources may be arbitrary wave generators (AWG), digital to analog converters (DACs), and/or other voltage signal generators. For example, the voltage sources 50 may comprise a plurality of longitudinal voltage drivers and/or voltage sources and/or at least one RF driver and/or voltage source. The voltage sources 50 may be electrically coupled to the corresponding potential generating elements and/or surface electrodes (e.g., control electrodes and/or RF electrodes) of the confinement apparatus 300, in an example embodiment.

In various embodiments, the quantum computer 110 comprises one or more magnetic field sources (not shown). For example, the magnetic field source may be an internal magnetic field source disposed within the cryogenic and/or vacuum chamber 40 and/or an external magnetic field source disposed outside of the cryogenic and/or vacuum chamber 40. In various embodiments, the magnetic field sources comprise permanent magnets, Helmholtz coils, electrical magnets, and/or the like. In various embodiments, the magnetic field sources are configured to generate a magnetic field and/or magnetic field gradient at one or more regions of the confinement apparatus 300 that has a particular magnitude and a particular magnetic field direction in the one or more regions of the confinement apparatus 300.

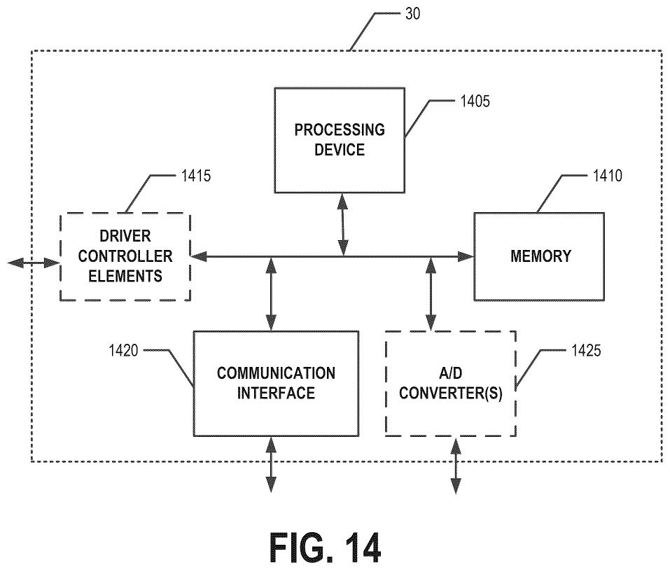

In various embodiments, the quantum computer 110 comprises an optics collection system 80 configured to collect and/or detect photons generated by atomic objects disposed in respective locations (e.g., during reading/detection operations) defined at least in part by the confinement apparatus. The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the atomic objects. While the optics collection system 80 is illustrated as being outside of the cryostat and/or vacuum chamber 40, in various embodiments, one or more optical elements and/or the one or more photodetectors of the optics collection system may be disposed within the cryostat and/or vacuum chamber 40. In various embodiments, the detectors may be in electronic communication with the controller 30 via one or more A/D converters 1425 (see FIG. 14) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage sources 50, magnetic field sources, cryogenic system and/or vacuum system controlling the temperature and/or pressure within the cryogenic and/or vacuum chamber 40, manipulation sources 60, and/or other systems controlling various environmental conditions (e.g., temperature, pressure, and/or the like) within the cryogenic and/or vacuum chamber 40, configured to manipulate and/or cause a controlled evolution of quantum states of one or more atomic objects within the confinement apparatus, and/or read and/or detect a quantum (e.g., qubit) state of one or more atomic objects within the confinement apparatus 300. For example, the controller 30 may cause a controlled evolution of quantum states of one or more atomic objects within the confinement apparatus to execute a quantum circuit and/or algorithm. For example, the controller 30 may read and/or detect quantum states of one or more atomic objects within the confinement apparatus at one or more points during the execution of a quantum circuit. In various embodiments, the atomic objects confined by the confinement apparatus are used as qubits of the quantum computer 110.

### Exemplary Integrated Atomic Source Device

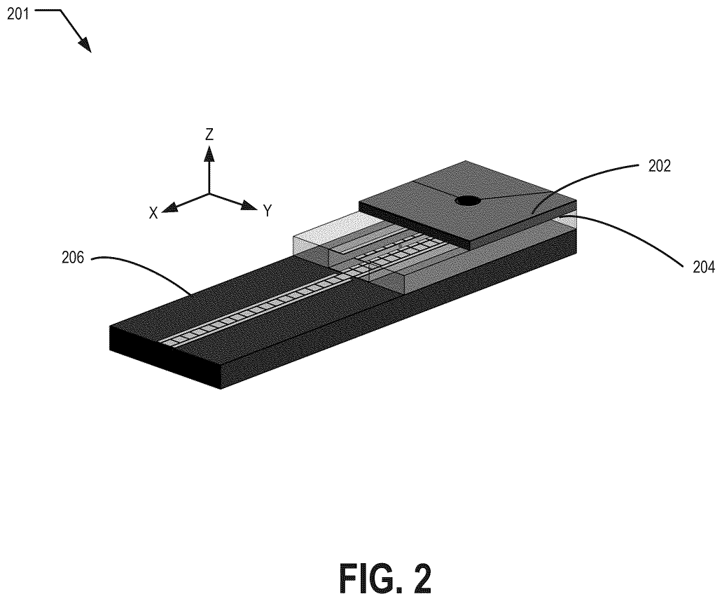

FIG. 2 provides a perspective view of an example integrated atomic source device 201, in accordance with an example embodiment. For example, in some embodiments, the integrated atomic source device 200 integrated with the confinement apparatus 300 may be an integrated atomic source device 201. In various embodiments, the integrated atomic source device 201 is comprised of a source assembly 202. In various embodiments, the integrated atomic source device 201 is comprised of the source assembly 202 and/or an object storage assembly 204. In various embodiments, the integrated atomic source device 201 is comprised of the source assembly 202, the object storage assembly 204, and/or the coupling assembly 206. An XYZ-axis legend illustrates exemplary directions of the integrated atomic source device, in various embodiments, the coupling assembly 206, the object storage assembly 204, and/or the source assembly 202 are coupled to one another along the Z-axis (e.g., along a substantially vertical axis).

In various embodiments, the coupling assembly 206, the object storage assembly 204, and/or the source assembly 202 are coupled to one another via die-bonding, wafer-level packaging, mounting the components to a shared mount and/or base, mounting the components to a dynamic stage (e.g., a piezo-stage), and/or via other methods. The mounting/bonding methods may use a bond, solder, adhesive, mechanical clamping, and/or other mounting/bonding types. The mounting/bonding methods may be permanent or reversible.

In various embodiments, the source assembly 202 is configured to provide objects (e.g., atomic objects originating from deposited atomic source material comprised within the source assembly 202). In various embodiments, the object storage assembly 204 is configured to store objects (e.g., ionized atoms) provided by the source assembly 202. In various embodiments, the coupling assembly 206 is configured to provide for composite integration of an atomic source with an atomic system (e.g., a quantum computer).

In various embodiments, the integrated atomic source device 201 comprises two or more atomic source devices. For example, an atomic confinement apparatus 300 may include multiple atomic source devices 201. In various embodiments, the two or more atomic source devices comprise source assemblies (e.g., 202) corresponding to different species of atoms. For example, an example atomic confinement apparatus 300 may include a first plurality of atomic source devices 201 configured to provide atomic objects of a first species to the confinement apparatus 300 and a second plurality of atomic source devices 201 configured to provide atomic objects of a second species to the confinement apparatus 300.

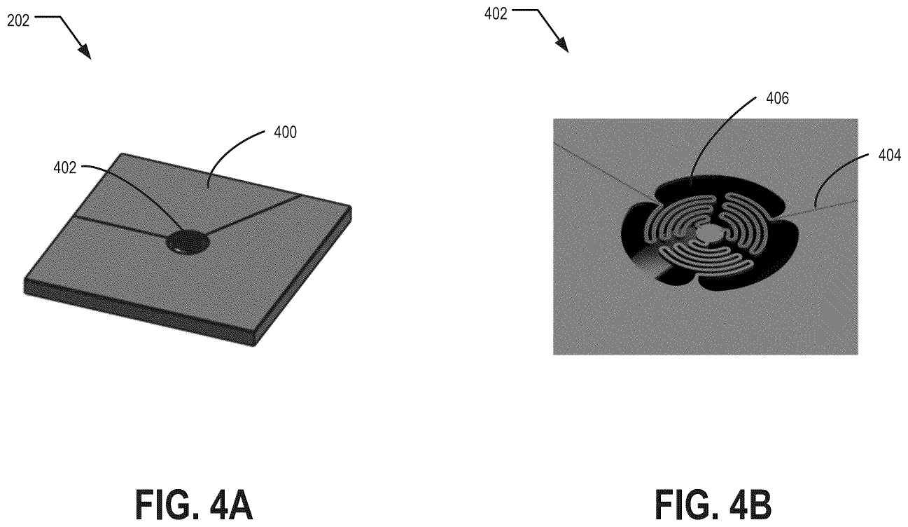

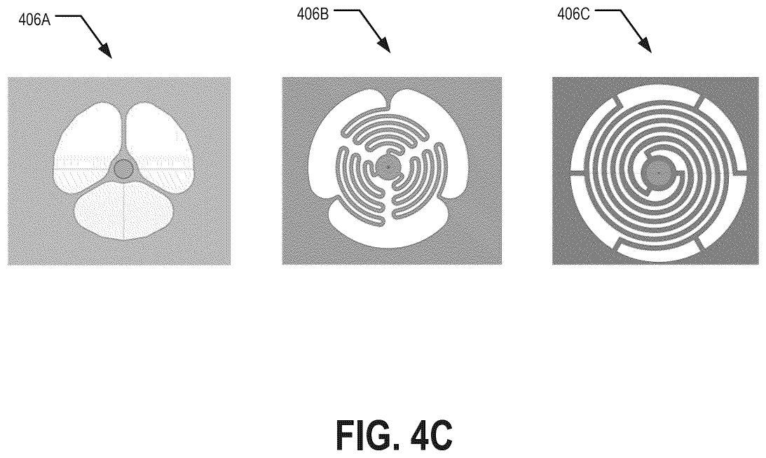

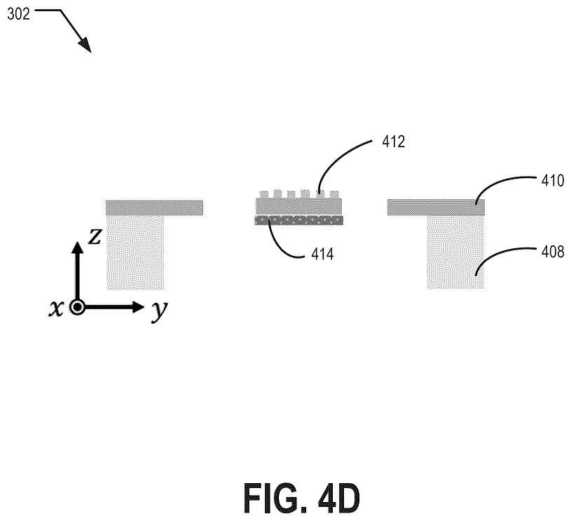

In various embodiments, the source assembly 202 (further described herein with respect to FIGS. 4A-4D) comprises a membrane-substrate package, comprising a membrane disposed on a substrate, a heater element, deposited atomic source material, and/or a passivation layer.

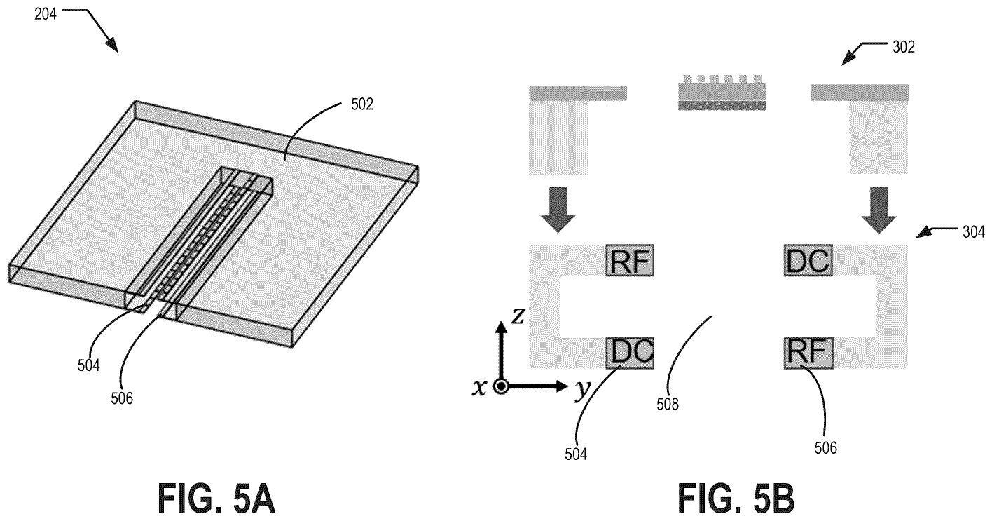

In various embodiments, the object storage assembly 204 (further described herein with respect to FIGS. 5A-5B) comprises a two-dimensional (2D) or three-dimensional (3D) confinement apparatus such as an ion trap. In various embodiments, the object storage assembly 204 comprises direct current (DC) electrodes and/or radiofrequency (RF) electrodes. In various embodiments, the DC electrodes are discrete electrodes. In various embodiments, the RF electrodes are continuous electrodes. In various embodiments, the RF electrodes are disposed across from one another in relation to the Y-axis (e.g., substantially horizontally). In various embodiments, the RF electrodes are disposed diagonally from one another. In various embodiments, the object storage assembly 204 provides for storage of ionized atoms originating from the deposited atomic source material of the source assembly 202.

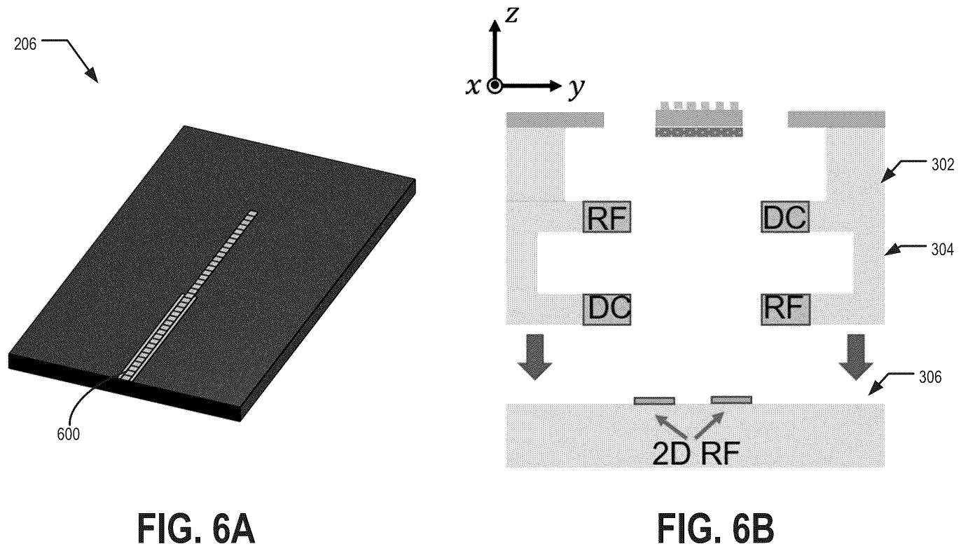

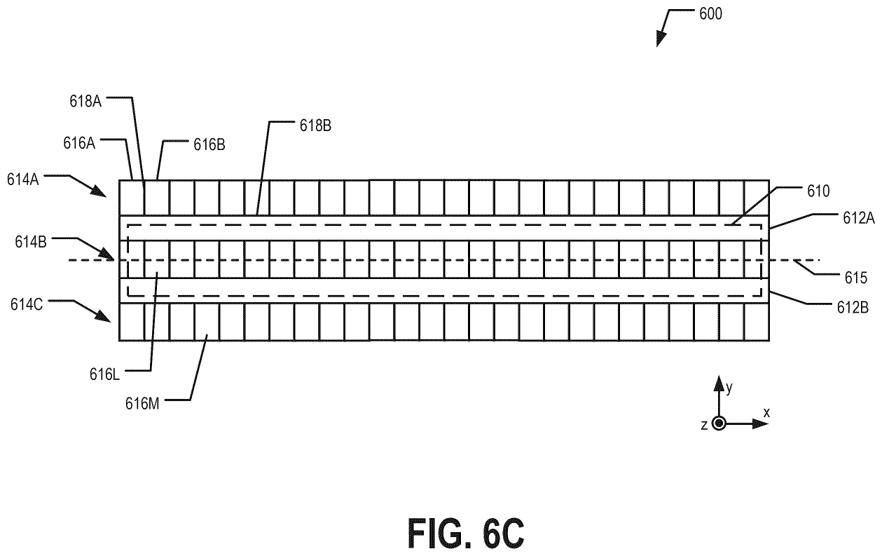

In various embodiments, the coupling assembly 206 (further described herein with respect to FIGS. 6A-6C) comprises a two-dimensional (2D) confinement apparatus. In various embodiments, the coupling assembly 206 is a surface integration trap. In various embodiments, the coupling assembly 206 comprises RF electrodes disposed along its X-axis. In various embodiments, the coupling assembly 206 provides for composite integration of an atomic source with a quantum computer and/or atomic system.

In various embodiments, assembly of the integrated atomic source device comprises coupling a source assembly to an object storage assembly and/or a coupling assembly. The source assembly may comprise a microfabricated heater element and deposited atomic source material. In various embodiments, the object storage assembly may comprise a 3D and/or a 2D confinement apparatus, such as an ion trap. In various embodiments, a 3D confinement apparatus includes front and/or back metallization on a substrate (e.g., an SiO2 substrate) with etching to remove a portion of the substrate e.g., via deep reactive ion etching (DRIE) and/or isotropic etching). The 3D confinement apparatus may be comprised of a substrate comprised of SiO2 (and/or other materials) with a trench etched most of the way through it such that it is connected it one side. In various embodiments, the trench is the volume in which ions will be trapped. The 3D confinement apparatus may include patterned electrodes on both sides of the trench (e.g., on the side proximate to the source assembly and/or on the side proximate to the coupling assembly). The electrodes may be disposed on a surface of the substrate and/or inset such that they are flush with the surface. The substrate may be etched on a surface opposite the electrodes. In various embodiments, the electrodes are continuous rail electrodes (e.g., radiofrequency electrodes) and/or discrete direct current electrodes. In various embodiments, the third component comprises the coupling assembly. The coupling assembly may be a surface confinement apparatus (e.g., a 2D ion trap). The 2D confinement apparatus may include metallization on a surface of a substrate (e.g., comprised of Si, glass, SiO2, and/or other materials), wherein the surface is etched via DRIE. The metallization may comprise continuous rails of radiofrequency electrodes and/or discrete direct current electrodes. The 2D confinement apparatus may comprise glass etching and/or undercutting such that the trapped ions are more exposed to metallic and/or conductive materials.

To assemble an integrated atomic source device, the source assembly and the object storage assembly may be coupled via die-bonding, wafer-level packaging, and/or pick-and-place technology. In various embodiments, the source assembly and the object storage assembly are couple such that the heater element is disposed over the trench of the 3D confinement apparatus of the object storage assembly. The coupled source assembly and object storage assembly are coupled to the coupling assembly such that the 2D confinement apparatus of the coupling assembly is aligned with the trench of the 3D confinement apparatus of the object storage assembly. In various embodiments, the coupled integrated atomic source device is approximately 500 microns in thickness.

In various embodiments, multiple source assembly and object storage assembly assemblies may be coupled to one coupling assembly. For example, assemblies for multiple ion species may be coupled to coupling assemblies via Y-junctions, which may enable deterministic crystal formation. In various embodiments, a crystal is comprised of a group and/or train of atomic objects. In various embodiments, deterministic crystal formation comprises formation of the group and/or train of atomic objects while the atomic species of the atomic objects of the crystal are known.

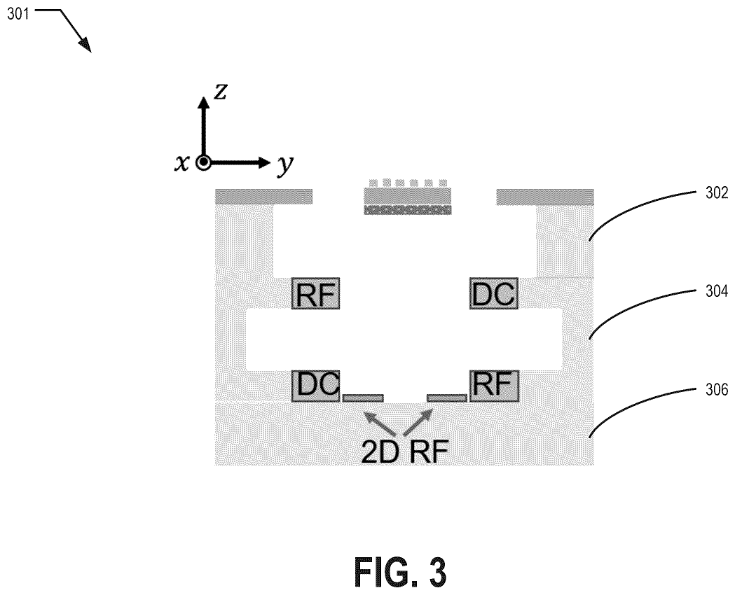

FIG. 3 provides a cross-sectional view 301 of the example integrated atomic source device 201 of FIG. 2, in accordance with an example embodiment. The cross-sectional view 301 comprises a cross-section 302 of the source assembly 202, a cross-section 304 of the object storage assembly 204, and a cross-section 306 of the coupling assembly 206 from a perspective facing the view 301 from along the X-axis.

The cross-section 302 shows a substrate, a membrane, a heater element, and/or deposited atomic source material (described in detail with respect to FIG. 4D). The cross-section 304 shows substantially diagonally disposed RF electrodes and substantially diagonally disposed DC electrodes. The cross-section 306 shows substantially horizontally disposed 2D RF electrodes.

### Exemplary Source Assembly

FIGS. 4A-4D show various views of an example source assembly. FIG. 4A provides a perspective view of the example source assembly 202 comprising at least a heater element 400 and deposited atomic source material, in accordance with an example embodiment. In various embodiments, the heater element 400 is comprised of a suspended membrane in thermal communication with a source component 402 and deposited atomic source material. In various embodiments, the heater element 400 is configured to heat the deposited atomic source material to cause the objects to be released therefrom. The heater element 400, in some embodiments, is comprised of a membrane-substrate package comprising a substrate and a membrane, wherein the membrane comprises the source component 402. In various embodiments, the membrane-substrate package is comprised of silicon on insulator (SOI), silicon and silicon dioxide (Si/SiO2), silicon nitride and silicon (SiN/Si), silicon nitride and silicon dioxide (SiN/SiO2), and/or other materials. In various embodiments, the membrane-substrate package is fabricated via lithography.

FIG. 4B provides a perspective view of an example source component 402, in accordance with an example embodiment. In various embodiments, the source component 402 comprises at least a heating portion 406 and/or one or more leg portions 404. In various embodiments, the source component 402 is comprised of a suspended membrane (e.g., the heating portion 406) coupled to legs (e.g., the one or more leg portions 404) configured to stop and/or decrease the dissipation of heat into the rest of the system. In various embodiments, the one or more leg portions 404 are configured to thermally isolate the heating portion 406 from the rest of the system. In various embodiments, the suspended membrane is less than approximately 10 microns in thickness, for example, the suspended membrane may be more preferably 2-5 microns in thickness, preferably less than 1 micron in thickness. In various embodiments, the heating portion 406 may be comprised of gold (Au), tungsten (W), molybdenum (Mo), Mo compounds, and/or other materials. In various embodiments, the source component 402 is fabricated via lithography. In various embodiments, the source component 402 is fabricated via optical lithography.

FIG. 4C provides top views of various example heater element configurations 406A, 406B, and 406C, in accordance with example embodiments. In various embodiments, the longer the legs (e.g., the one or more leg portions 404), the more thermally isolated the central region of the heater (e.g., the heating portion 406) becomes. For example, as heater elements are configured with longer legs, less power may be lost to the rest of the system, allowing for shorter heat times (e.g., to reach sublimation temperatures for various atomic source materials). In various embodiments, variously shaped legs may reduce thermal and/or mechanical stresses on the system.

In various embodiments, source component 402 may be variously configured. For example, the source component 402 may be a thermally isolated region including a heating element and atomic source material. In some examples, the source component 402 may comprise an electrical resistive heater. In various embodiments, an electrical resistive heater may comprise a resistive wire (e.g., patterned from a metal) which traverses a leg (e.g., a leg of the one or more leg portions 404) to the suspended membrane (e.g., the heating portion 406), traverses a pattern configured to elongate a path of the resistive wire, and/or traverses another (or the same) leg out. In another example, the source component 402 may be a film in the suspended membrane region configured to absorb light (e.g., from an incident laser beam) and generate heat based on the absorbed light. In another example, an incident laser beam may be used to directly ablate the atomic source material (e.g., via high power, short pulse laser shining directly onto the atomic source material).

FIG. 4D provides a cross-sectional view 302 of an example source assembly comprising at least a heater element and deposited atomic source material, in accordance with an example embodiment. The cross-section 302 shows a substrate 408, a membrane 410, a heater element 412, and/or deposited atomic source material 414. In various embodiments, the substrate 408 is comprised of insulator, SiO2, Si, and/or other materials. In various embodiments, the membrane 410 is comprised of Si, SiN, and/or other materials. In various embodiments, the heating element 412 is comprised of gold (Au), tungsten (W), molybdenum (Mo), Mo compounds, and/or other materials. In various embodiments, the deposited atomic source material 414 is comprised of neutral atoms. In various embodiments, the deposited atomic source material 414 is of one or more species of atom. In various embodiments, the deposited atomic source material 414 is covered by a passivation layer. For example, the deposited atomic source material 414 may be covered by a passivation layer if the atomic source material is air-sensitive and/or otherwise reactive. In various embodiments, the heater element of view 302 is comprised of an optically absorptive material (e.g., Si) and the heater element is configured to heat the deposited atomic source material responsive to absorbing optical power.

As described herein with respect to FIGS. 4A-4D, in various embodiments, the heater element 400 (e.g., a microfabricated heater) is a suspended membrane in thermal communication with a source component 402 and deposited atomic source material 414. The deposited atomic source material 414 may sublimate in vacuum when heat is applied via the source component 402. Due to high thermal resistance in areas at least a distance away from the source component 402, the source component 402 may reach high temperatures with low electrical power (e.g., on the order of 10 mW). In various embodiments, current is run through the source component 402 and the deposited atomic source material (e.g., a neutral metal) sublimates. For example, the heater element 412 may comprise a conductive material having a non-zero resistance such that causing a current to flow through the heater element 412 causes the heater element 412 to generate heat that heats the atomic source material. In another example, the heater element 412 comprises an optically absorbent material such that applying a light (e.g., laser beam and/or a non-coherent beam of light) to the heater element 412 causes the heater element 412 to convert the optical power to heat (e.g., via absorption of the applied light) that heats the atomic source material.

In various embodiments, the source component 402 itself is a small, suspended membrane coupled to thin legs, which are configured to stop and/or decrease dissipation of heat into the rest of the system. The source component 402 may be turned on and off rapidly. For example, the source component 402 may be turned on and off without affecting the operation of the atomic confinement apparatus (e.g., quantum computer) to which it is coupled. For example, the source component 402 operating at approximately 750 K may have negligible effect on the rest of the quantum computer, which operates at approximately 40 K. Thus, the source component 402 may have a minimal thermal effect on the otherwise cryogenic system. For example, due to the small size and mass of the heater element 412, the source component 402 may be used to heat the atomic source material to a temperature sufficient to sublimate atomic objects from the atomic source material without providing a significant amount of heat to the interior of the cryostat and/or vacuum chamber 40.

In various embodiments of the present disclosure, advantages of the source assembly of FIGS. 4A-4D include its quick thermal response and/or its small size relative to the atomic confinement apparatus to which it is coupled. Moreover, high ion capture efficiency results from the source component's ability to be positioned close to the atomic confinement apparatus, further leading to decreased heater temperatures and increased heating portion lifetimes (e.g., due to increased times used for the atomic source material to completely sublimate such that none is left on the suspended membrane). In addition, multiple source components may be included per ion source, leading to greater redundancy, which is advantageous as a backup and as a method for scaling up atomic confinement apparatuses.

### Exemplary Object Storage Assembly

FIG. 5A provides a perspective view of the example object storage assembly 204, in accordance with an example embodiment. In various embodiments, the object storage assembly 204 comprises a substrate 502, DC electrodes 504, and/or RF electrodes 506. The substrate 502 may be comprised of glass, silicon oxide (SiO₂), silicon (Si), ceramics, and/or other materials into which a trench is etched. The DC electrodes 504, in various embodiments, are discrete electrodes. The RF electrodes 506, in various embodiments, are continuous electrodes. In some examples, the RF electrodes 506 are configured to generate a tube-shaped potential well, the DC electrodes 504 are configured to cap ends of the tube-shaped potential, and/or the DC electrodes 504 are further configured to move atomic objects along the length of the tube-shaped potential generated by the RF electrodes 506.

FIG. 5B provides a cross-sectional view 304 of an example object storage assembly, in accordance with an example embodiment. The example object storage assembly of view 304, shown head-on along the X-axis, includes the substrate 502, the DC electrodes 504, the RF electrodes 506, and a target location at which ions may be confined. In various embodiments, the DC electrodes 504 are disposed approximately diagonally across from one another. In various embodiments, the RF electrodes 506 are disposed approximately diagonally across from one another. In various embodiments, the target location is substantially centered between the DC electrodes 504 and the RF electrodes 506.

The object storage assembly of FIGS. 5A-5B, in various embodiments, is configured to receive objects (e.g., atoms and/or ions) emitted by the source assembly 202 and/or confine them or maintain them within a defined volume 508 (e.g., such as the target location). In various embodiments, the object storage assembly 204 is configured to be reloaded with objects before it becomes empty, such that it stores and/or provides a constant supply of objects. In various embodiments, the object storage assembly 204 comprises a 3D confinement apparatus and/or a 2D confinement apparatus. In various embodiments, the object storage assembly 204 comprises one or more optical components configured to provide an ionizing beam configured for ionizing objects emitted by the source assembly 202 and/or received into the defined volume 508.

As described herein with respect to FIGS. 5A-5B, in various embodiments, an object storage assembly is external ion storage, for example, for a quantum computer (e.g., wherein the object storage assembly is external to the quantum computer, hence the name “external ion storage”). In various embodiments, external ion storage for a quantum computer is a 3D confinement apparatus. A 3D confinement apparatus strongly holds ions and can be loaded with a large quantity of ions, for example, without waiting for long periods for the atoms to become ionized and trapped. In various embodiments, after the deposited atomic source material sublimates, the neutral atoms are ionized. For example, lasers may be used to ionize the neutral atoms, which are held as ions in the object storage assembly. Additionally or alternatively, the neutral atoms may be ionized via thermal/surface ionization as they separate from the surface to which they were attached.

In various embodiments of the present disclosure, advantages of the object storage assembly of FIGS. 5A-5B include its high-capacity ion storage, which may result in on-demand and/or deterministic loading of ions. In various embodiments, two or more object storage assemblies are coupled to a quantum computer in order to separate ion sources for different species of atoms, thus aiding in deterministic building of ion crystals. Bulk and/or 3D confinement apparatuses, which are various examples of object storage assemblies, offer long-term ion storage without affecting quantum operations of the quantum computer to which they may be coupled. Further advantages of object storage assemblies include enabling drastic miniaturization of vacuum, optical, and/or electronic systems of atomic confinement apparatuses; compatibility with micro-vacuum architectures is an advantage of object storage assemblies.

### Exemplary Coupling Assembly

FIG. 6A provides a perspective view of the example coupling assembly 206, in accordance with an example embodiment. In various embodiments, the coupling assembly 206 comprises a substrate and/or electrodes 600. In various embodiments, the electrodes 600 comprise DC electrodes and/or RF electrodes. In various embodiments, the DC electrodes are discrete electrodes. In various embodiments, the RF electrodes are continuous electrodes. In various embodiments, the RF electrodes are 2D RF electrodes.

FIG. 6B provides a cross-sectional view 306 of an example coupling assembly, in accordance with an example embodiment. The example object storage assembly of view 306, shown head-on along the X-axis, includes the substrate and the electrodes 600. In various embodiments, the electrodes 600 are disposed approximately horizontally from one another in relation to the Y-axis.

FIG. 6C provides a top view of at least a portion of an example confinement apparatus 600 that may be used to confine one or more atomic objects. For example, in the illustrated embodiment, the confinement apparatus is a confinement apparatus (e.g., a surface ion trap) and the atomic objects are ions and/or ion crystals. The linear portion of the example confinement apparatus 600 may be part of a larger linear geometry of the confinement apparatus or may be part of a two-dimensional or three-dimensional geometry of the confinement apparatus, in various embodiments.

In an example embodiment, the confinement apparatus 600 (e.g., surface ion trap) is fabricated as part of a confinement apparatus chip and/or part of a confinement apparatus and/or package. In an example embodiment, the confinement apparatus 600 is at least partially defined by a number of RF electrodes 612 (e.g., 612A, 612B). While the RF electrodes 612 are illustrated as generally rectangular, in various embodiments, the RF electrodes 612 may have various geometries, as appropriate for the application. In various embodiments, the confinement apparatus 600 is at least partially defined by a number of sequences of control electrodes 614 (e.g., 614A, 614B, 614C). Each sequence of control electrodes 614 comprises a plurality of control electrodes 616 (e.g., 616A, 616B, . . . , 616L, 6216M). While the control electrodes 616 are illustrated as generally rectangular, in various embodiments, the control electrodes 616 may have various geometries, as appropriate for the application.

In an example embodiment, each control electrode 616 and/or at least a non-empty subset of the control electrodes 616 may be operated independently via the application of control signals thereto. In an example embodiment, at least some of the control electrodes 616 are operated via application of a broadcast control signal. In an example embodiment, the confinement apparatus 600 is a surface Paul trap with symmetric RF electrodes 612. In various embodiments, the RF electrodes 612 and the control electrodes 616 generate potentials and/or fields that are experienced by atomic objects within respective confinement regions of the confinement apparatus 600. In particular, the RF electrodes 612 may be configured to define the respective confinement regions 610 of the confinement apparatus 300 and the control electrodes 616 may be configured to at least partially control movement and/or motion of atomic objects within the respective confinement regions.

A gap 618A is disposed between adjacent control electrodes 616. For example, control electrodes 616A, 616B are adjacent electrodes as the control electrodes 616A, 616B are separated only by the gap 618A (e.g., there are no other electrodes between the adjacent control electrodes 616A, 616B). In various embodiments, a control electrode 616 and an adjacent RF electrode 612 are separated by a gap 618B. In various embodiments, the gap 618 (e.g., 618A, 618B) has a depth d to width w ratio of at least 0.9. In various embodiments, the depth d to width w ratio of the gap 618 is greater than 1.1, greater than 1.5, in a range of 1.0 to 3, in a range of 1.0 to 5, in a range of 1.1 to 5, and/or the like.

The coupling assembly of FIGS. 6A-6C, in various embodiments, is configured to receive objects from the storage assembly 204 and/or couple them into a confinement region of a confinement apparatus. In various embodiments, the coupling assembly 206 is configured to generate at least one confinement region. In various embodiments, the coupling assembly 206 comprises a 2D ion trap. In various embodiments, the confinement apparatus is a trapped-ion quantum charge-coupled device (QCCD) quantum computer.

As described herein with respect to FIGS. 6A-6C, in various embodiments, a coupling assembly is a surface integration trap. In various embodiments, a surface integration trap is configured to transport ions from an external ion storage to a confinement apparatus of a quantum computer. For example, the surface integration trap may be a buffer trap that couples an ion source to an external ion storage (e.g., the source assembly 202 to the object storage assembly 304).

In various embodiments of the present disclosure, advantages of the coupling assembly of FIGS. 6A-6C include composite integration of an integrated atomic source device (e.g., 201) with an atomic confinement apparatus (e.g., a trapped-ion QCCD quantum computer). The composite integration allows for deterministic, simplified loading of ions, scalability, simplified fabrication (e.g., by lacking a load hole through one or more components of the assemblies), and/or the ability to configure the composite system to include multiple integrated atomic source devices per atomic confinement apparatus per species of atom (e.g., for backup and/or redundancy).

### Exemplary Integrated Atomic Source Device Having Various Electrode Configurations

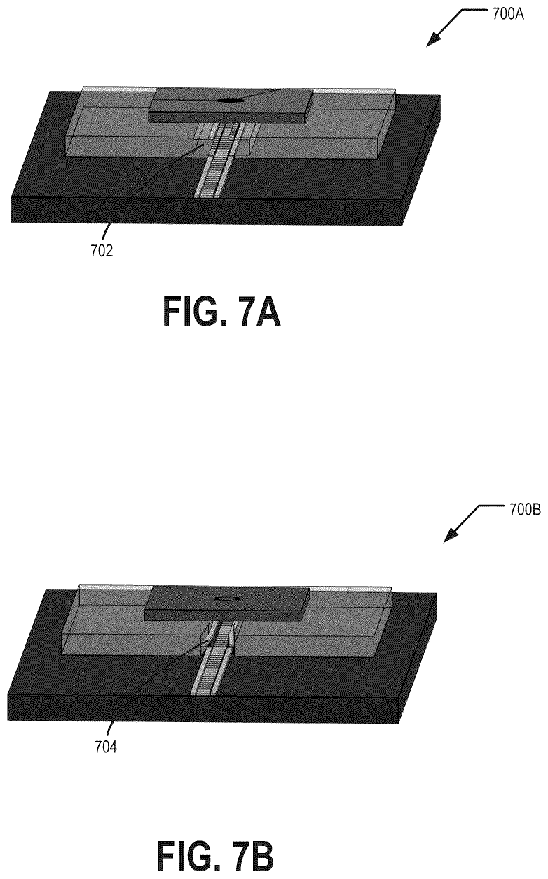

FIG. 7A provides a perspective view 700A of an example integrated atomic source device comprising diagonal RF electrodes 702, in accordance with an example embodiment. The view 700A shows the electrodes 702. In various embodiments, the electrodes 702 are disposed approximately diagonally to one another. In various embodiments, the electrodes 702 are continuous RF electrodes.

Advantages of various electrode configurations may include case of fabrication and/or integration with the rest of the system. For example, the diagonal configuration of the electrodes 702 may be straightforward to fabricate. In various embodiments, since the substrate may be comprised a transparent material (e.g., glass), light may be delivered through the sides of device to the confinement region (e.g., and collected from the confinement region through the sides of the substrate), allowing for the introduction of ionizing laser beams and light to cool the motional degrees of freedom of the confined atomic objects. Additionally, light may more easily be collected from that region to monitor the trapped atomic objects.

FIG. 7B provides a perspective view 700B of an example integrated atomic source device comprising tapered horizontal RF electrodes 704, in accordance with an example embodiment. The view 700B shows the electrodes 704. In various embodiments, the electrodes 704 are disposed approximately horizontally from one another. In various embodiments, the electrodes 704 are tapered.

Advantages of various electrode configurations may include case of fabrication and/or integration with the rest of the system. The horizontal configuration of the RF electrodes 704 may allow for easier configuration of a continuous coupling between the coupling assembly 206 and the object storage assembly 204 (e.g., by having an overlapping confinement region that may include variable and/or tapered RF electrode distances). The horizontal configuration of the RF electrodes 704 may allow for improved optical delivery through integrated photonic waveguides in the substrate of the coupling assembly 206.

### Exemplary Atomic Confinement Apparatus Configurations

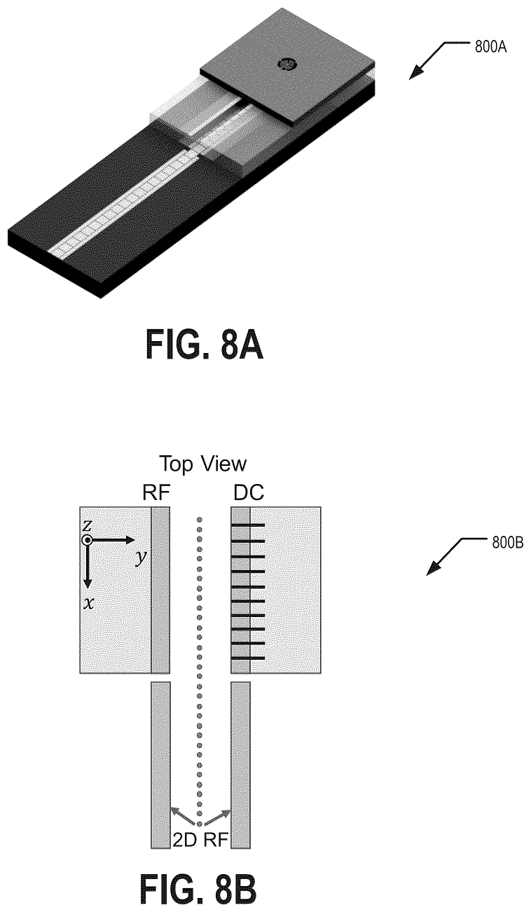

FIGS. 8A-8B provide views of an example atomic confinement apparatus configuration comprising hurdle butt-coupling. FIG. 8A provides a perspective view 800A of an example atomic confinement apparatus configuration comprising hurdle butt-coupling, in accordance with an example embodiment. FIG. 8B provides a top view 800B of an example atomic confinement apparatus configuration comprising hurdle butt-coupling, in accordance with an example embodiment.

The configuration of FIGS. 8A-8B butts up two or more confinement potentials proximate to one another (so-called “butt-coupled”). In this configuration, the two confinement apparatuses are proximate to one another and there is a small potential barrier between them that the confined atomic object may jump through and/or over (so-called “hurdle”). For example, the hurdle/butt-couple configuration may be variously applied. In various embodiments, the object storage assembly 204 is bonded directly onto a chip that comprises the coupling assembly 206 (e.g., the wafer of the coupling assembly 206 may be used as the substrate for the object storage assembly 204).

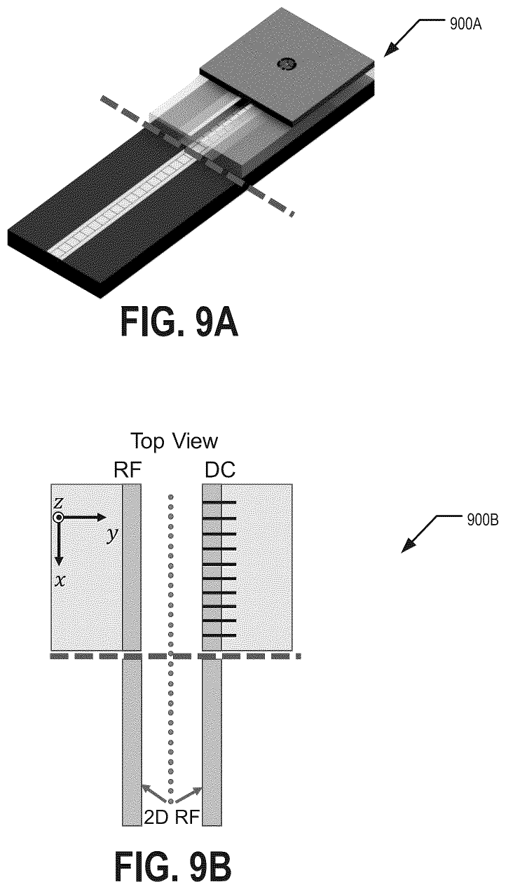

FIGS. 9A-9B provide views of an example atomic confinement apparatus configuration comprising chip-to-chip butt coupling. FIG. 9A provides a perspective view 900A of an example atomic confinement apparatus configuration comprising chip-to-chip butt coupling, in accordance with an example embodiment. FIG. 9B provides a top view 900B of an example atomic confinement apparatus configuration comprising chip-to-chip butt coupling, in accordance with an example embodiment.

The configuration of FIGS. 9A-9B butts up two or more confinement potentials proximate to one another (so-called “butt-coupled”). In this configuration, the two confinement apparatuses are proximate to one another and there is a small potential barrier between them that the confined atomic object may jump through and/or over (so-called “hurdle”). For example, the hurdle/butt-couple configuration may be variously applied. In various embodiments, object storage assembly 204 and the coupling assembly 206 have separate substrates, as represented by the dashed line (e.g., they have completely separate stacks of components and/or they are placed directly next to each other).

The hurdle/butt-couple configurations of FIGS. 8A-8B and FIGS. 9A-9B may be achieved in the diagonal and/or horizontal RF electrode configurations.

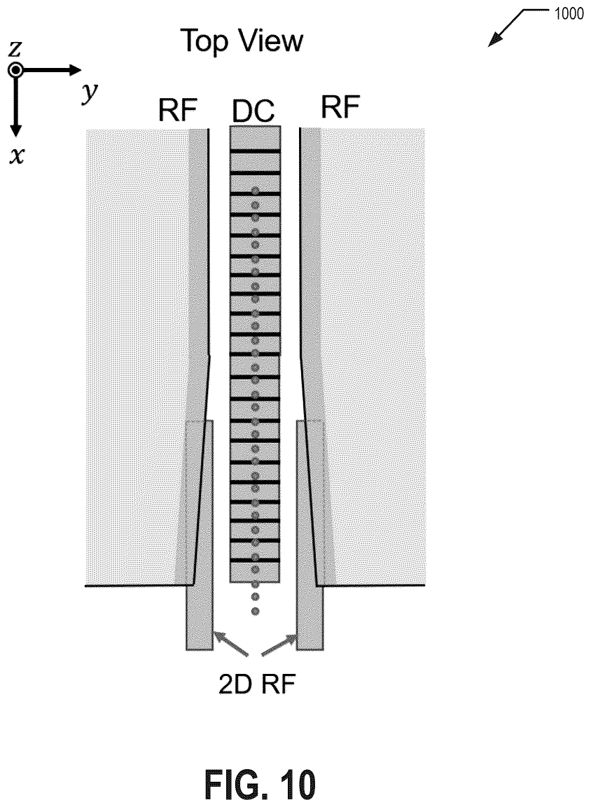

FIG. 10 provides a top view of an example atomic confinement apparatus configuration comprising a tapered handoff, in accordance with an example embodiment. In the configuration of FIG. 10, the confinement region of the object storage assembly 204 and the coupling assembly 206 may overlap such that there is no potential barrier and/or no hurdle over which atomic object may jump to move between regions. In the example of FIG. 10, one assembly gradually tapers to create a smooth transition in the confinement region from one (e.g., the object storage assembly 204) to another (e.g., the coupling assembly 206). The configuration of FIG. 10 may be achieved with the diagonal and/or horizontal RF electrode configurations. In various embodiments, the configuration of FIG. 10 may include tapered and/or substantially straight electrodes.

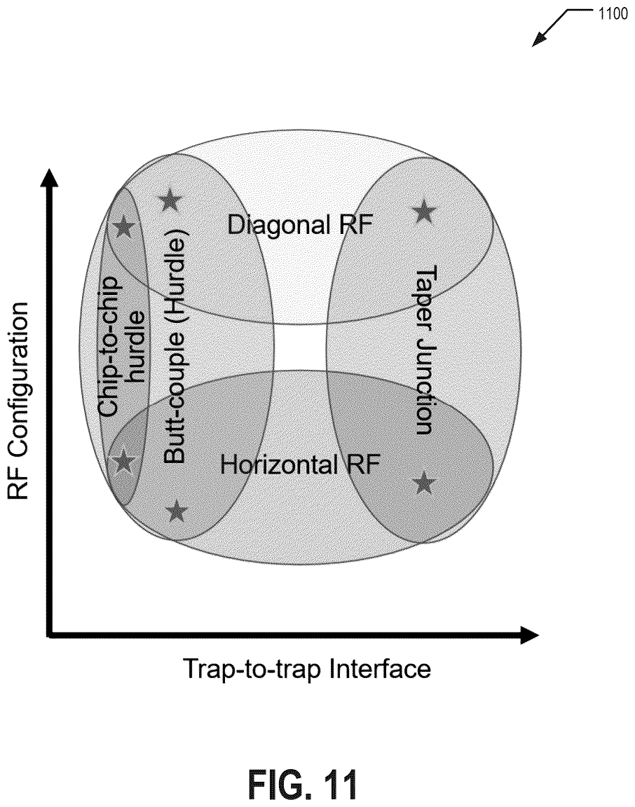

FIG. 11 provides a diagram 1100 visualizing example atomic confinement apparatus configurations, in accordance with an example embodiment. In various embodiments, the object storage assembly comprises substantially horizontal RF electrodes, the object storage assembly is aligned with the coupling assembly via a taper junction. In various embodiments, the object storage assembly comprises substantially diagonal RF electrodes, and the object storage assembly is aligned with the coupling assembly via a taper junction. In various embodiments, the object storage assembly comprises substantially horizontal RF electrodes, and the object storage assembly is aligned with the coupling assembly via butt-coupling. In various embodiments, the object storage assembly comprises substantially diagonal RF electrodes, and the object storage assembly is aligned with the coupling assembly via butt-coupling. In various embodiments, the object storage assembly comprises substantially horizontal RF electrodes, and the object storage assembly is aligned with the coupling assembly via a chip-to-chip hurdle. In various embodiments, the object storage assembly comprises substantially diagonal RF electrodes, and wherein the object storage assembly is aligned with the coupling assembly via a chip-to-chip hurdle.

### Exemplary Method for Fabricating an Integrated Atomic Source Device

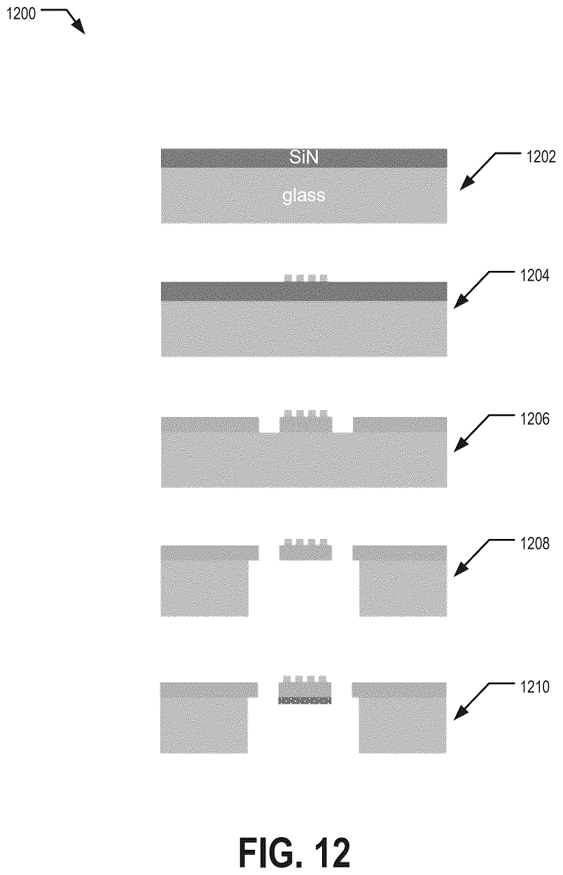

FIG. 12 provides a cross-sectional view of an example method for fabricating a source assembly, in accordance with an example embodiment. Source assemblies may be fabricated in various ways.

At step 1202, a membrane-substrate package may be fabricated. In various embodiments, the membrane-substrate package is fabricated based on lithography techniques. In various embodiments, the membrane-substrate package is comprised of a SiN membrane fabricated from a thin material film (e.g., a thin SiN film) on a SiO2 substrate. For example, advantages of such a membrane-substrate package include that SiN produces robust membranes and SiO2 is transparent, resulting in an optically transparent package. Moreover, such a package has poor thermal conductivity, resulting in a low heat load on the rest of the integrated atomic source device and the confinement apparatus as a whole.

In various embodiments, the materials comprising the membrane-substrate package are SOI, Si/SiO2, SiN/Si, and/or other materials. The membrane-substrate package, in various embodiments, is approximately less than or equal to 10 microns in height, although it may be much thinner or much thicker based on application needs.

At step 1204, a source component may be fabricated. In various embodiments, the source component is fabricated using lithography, for example, such as optical lithography. The source component may be comprised of Au, W, Mo, Mo compounds, and/or other materials. In various embodiments, other materials may be used, for example, if the system is subjected to higher operating temperatures, based on application needs.

At step 1206, the membrane may be etched to further define the source component. For example, legs (e.g., such as the one or more leg portions 404) supporting the membrane may be lithographically defined.

At step 1208, the SiO2 on the side of the membrane opposite the source component may be removed. For example, the SiO2 on the side of the membrane opposite the source component may be removed via back etching (e.g., wet and/or dry etching, deep reactive ion etching (DRIE), etc.). In various embodiments, the membrane is fabricated from the thin film of the membrane.

At step 1210, atomic source material may be deposited on the side of the membrane opposite the source component. In various embodiments, if the side of the membrane comprising the source component receives heat, the atomic source material is warmed up and sublimates. For example, the sublimated atoms may ionized and confined by a 2D and/or 3D trap of an object storage assembly. In various embodiments, the source assembly is a standalone ion source.

In various embodiments, the atomic source material is covered by a passivation layer, for example, if the atomic source material is air-sensitive and/or otherwise reactive. In various embodiments, the fabrication process may be partially or wholly performed in an inert gas environment (e.g., a glovebox).

In various embodiments, the source component may be fabricated out of an optically absorptive film (e.g., out of Si, some optically absorbing dielectric material, some optically absorbing material, and/or other materials) such that a laser may deposit thermal power to the film. In various embodiments, the heater element is comprised of an optically absorptive material and the heater element is configured to heat the deposited atomic source material responsive to absorbing optical power.

In various embodiments, the atomic source material may receive thermal power from a laser, for example, from the “top down” if the membrane is optically transparent.

In various embodiments, the source assembly includes a series of atomic sources, such that if one is depleted, there are others. In various embodiments, the source assembly includes various heater elements with different species of atomic source material, as needed for various applications.

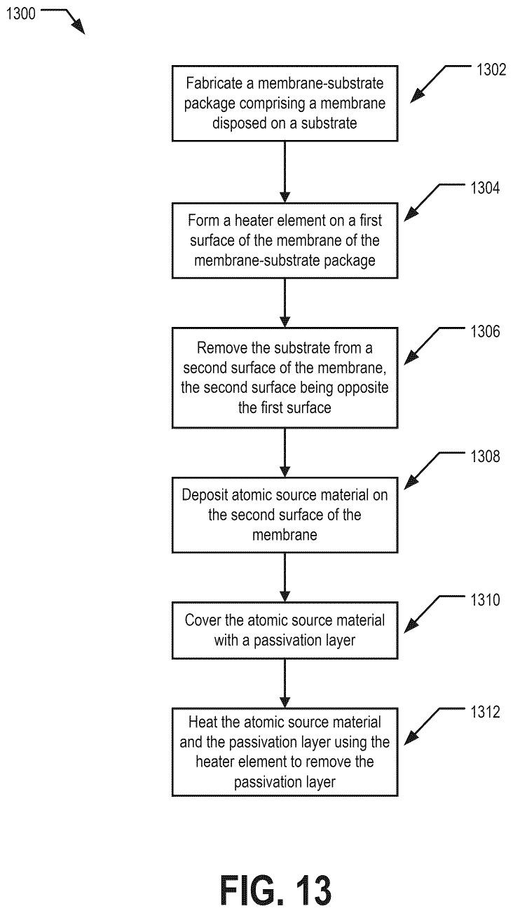

FIG. 13 provides a flowchart of an example method for fabricating an integrated atomic source device, in accordance with an example embodiment.

At step 1302, a membrane-substrate package comprising a membrane disposed on a substrate is fabricated. In various embodiments, the membrane-substrate package is fabricated based on lithography techniques. In various embodiments, the membrane-substrate package is comprised of a SiN membrane on a SiO2 substrate. For example, advantages of such a membrane-substrate package include that SiN produces robust membranes and SiO2 is transparent, resulting in an optically transparent package. Moreover, such a package has poor thermal conductivity, resulting in a low heat load on the rest of the integrated atomic source device and the confinement apparatus as a whole. In various embodiments, the materials comprising the membrane-substrate package are SOI, Si/SiO2, SiN/Si, and/or other materials. The membrane-substrate package, in various embodiments, is approximately less than or equal to 10 microns in height, although it may be much thinner or much thicker based on application needs.

At step 1304, a heater element is formed on a first surface of the membrane of the membrane-substrate package. In various embodiments, a heater element may be fabricated. In various embodiments, the heater element is fabricated using lithography, for example, such as optical lithography. The heater element may be comprised of Au, W, Mo, Mo compounds, and/or other materials. In various embodiments, other materials may be used, for example, if the system is subjected to higher operating temperatures, based on application needs.

At step 1306, the substrate is removed from a second surface of the membrane, the second surface being opposite the first surface. In various embodiments, the SiO2 on the second surface (e.g., the side of the membrane opposite the first surface comprising the heater element) may be removed. For example, the SiO2 on the second surface may be removed via back etching. In various embodiments, the membrane is fabricated from the thin film of the membrane.

At step 1308, atomic source material is deposited on the second surface of the membrane. In various embodiments, atomic source material may be deposited on the side of the membrane opposite the heater element. In various embodiments, if the side of the membrane comprising the heater element receives heat, the atomic source material is warmed up and sublimates. For example, the sublimated atoms may ionized and confined by a 2D and/or 3D trap of an object storage assembly. In various embodiments, the source assembly is a standalone ion source.

At step 1310, the atomic source layer is covered with a passivation layer. In various embodiments, the atomic source material is covered by a passivation layer, for example, if the atomic source material is air-sensitive and/or otherwise reactive. In various embodiments, the fabrication process may be partially or wholly performed in an inert gas environment (e.g., a glovebox).

At step 1312, the atomic source material and the passivation layer are heated using the heater element to remove the passivation layer.

### Technical Advantages

Some conventional trapped ion quantum computers (e.g., QCCD-based quantum computers) use confinement apparatuses disposed within vacuum chambers and are maintained at cryogenic temperatures such that the vacuum chamber is also a cryostat. Some conventional assemblies for providing ions to the confinement apparatus include sublimating an atomic source in an oven that is located a distance (e.g., approximately 0.5 meters) from the confinement apparatus and directing at least some of the atomic flux through a loading hole formed through the confinement apparatus. In some conventional assemblies, the oven must be maintained a distance away from the confinement apparatus because of the large amount of heat generated when the oven is in use and the higher pressure created by the oven when it is running at high flux.

Embodiments of the present disclosure provide technical solutions to these technical problems. Various embodiments provide confinement apparatuses, systems comprising confinement apparatuses, and/or methods for fabricating confinement apparatuses that comprise integrated atomic source devices. Various embodiments provide confinement apparatuses, systems comprising confinement apparatuses, and/or methods for fabricating confinement apparatuses that comprise miniature integrated atomic source devices.

In various embodiments, the integrated atomic source devices take the form of small chips. In various embodiments, the integrated atomic source devices are coupled to the confinement apparatus without compromising the vacuum and/or without adding large heat loads.

Thus, various embodiments provide confinement apparatuses having integrated atomic source devices (e.g., integrated ion sources). Various embodiments provide systems that include such confinement apparatuses and various embodiments provide methods for fabricating such confinement apparatuses. Various embodiments therefore provide an improvement to the field of confinement apparatuses, systems including confinement apparatuses, and methods for fabricating confinement apparatuses.

Advantages of integrated atomic source devices include, for example, a quick thermal response due to the small size of the membrane comprising the heater element and atomic source material. Due to the small size of the membrane comprising the heater element and the atomic source material, there may be multiple heater elements (and atomic source material) per coupling assembly. Similarly, low amounts of energy and atomic source material may be used in integrated atomic source devices. Due to the proximity of the source assembly to the coupling assembly, more sublimated atoms can be collected from an integrated atomic source device than from conventional assemblies. These advantages and more further lead to an increase in ability to scale quantum computers using integrated atomic source devices (e.g., since they remove the additional volume and large heat loads required by conventional assemblies).

Various embodiments therefore provide an improvement to the field of confinement apparatuses, systems including confinement apparatuses, and methods for fabricating confinement apparatuses.

### Example Controller

Various embodiments provide systems comprising confinement apparatuses 201, 300, 700A, 700B, 800A, 900A, 1000. For example, various atomic systems, quantum systems, and/or the like may use a confinement apparatus 201, 300, 700A, 700B, 800A, 900A, 1000 to confine one or more atomic objects. In an example embodiment, the system is a quantum charge-coupled device (QCCD-based) quantum computer 110 or other quantum computer. In various embodiments, the system (e.g., quantum computer 110) includes a controller 30 configured to control various elements of the system. For example, the controller 30 may be configured to control the voltage sources 50, a cryogenic system and/or vacuum system for controlling the temperature and pressure within the cryogenic and/or vacuum chamber 40, manipulation sources 60, magnetic field sources, and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more atomic objects confined by the confinement apparatus, and/or read and/or detect a quantum state of one or more atomic objects confined by the confinement apparatus.

As shown in FIG. 14, in various embodiments, the controller 30 may comprise various controller elements including one or more processing devices 1405, memory 1410, driver controller elements 1415, a communication interface 1420, analog-digital converter elements 1425, and/or the like. For example, the one or more processing devices 1405 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 1405 of the controller 30 comprises a clock and/or is in communication with a clock. In various embodiments, this clock defines the clock cycles of the system.

For example, the memory 1410 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1410 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 1410 (e.g., by a processing device 1405) causes the controller 30 to perform one or more steps, operations, processes, procedures and/or the like described herein for controlling one or more components of the quantum computer 110 (e.g., voltages sources 50, manipulation sources 60, magnetic field sources, and/or the like) to cause a controlled evolution of quantum states of one or more atomic objects, detect and/or read the quantum state of one or more atomic objects, and/or the like.

In various embodiments, the driver controller elements 1415 may include one or more drivers and/or controller elements each configured to control one or more drivers. In various embodiments, the driver controller elements 1415 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 1405). In various embodiments, the driver controller elements 1415 may enable the controller 30 to operate a manipulation source 60. In various embodiments, the drivers may be laser drivers; vacuum component drivers; drivers for controlling the flow of current and/or voltage applied to the electrodes (e.g., the RF, control, and/or other electrodes of the confinement apparatus 201, 300, 700A, 700B, 800A, 900A, 1000) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the electrodes (e.g., control electrodes 616 and/or RF electrodes 612). In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system 80. For example, the controller 30 may comprise one or more analog-digital converter elements 1425 configured to receive signals from one or more detectors, optical receiver components, calibration sensors, and/or the like.

In various embodiments, the controller 30 may comprise a communication interface 1420 for interfacing and/or communicating with one or more computing entities 10. For example, the controller 30 may comprise a communication interface 1420 for receiving executable instructions, command sets, and/or the like from the computing entity 10 and providing output received from the quantum processor 115 (e.g., via the optics collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Example Computing Entity

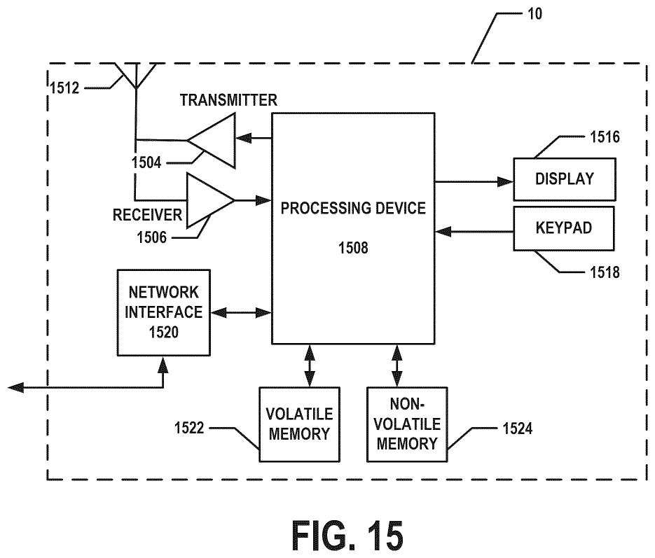

FIG. 15 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 15, a computing entity 10 can include an antenna 1512, a transmitter 1504 (e.g., radio), a receiver 1506 (e.g., radio), and a processing device 1508 that provides signals to and receives signals from the transmitter 1504 and receiver 1506, respectively.

The signals provided to and received from the transmitter 1504 and the receiver 1506, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 1520 configured to communicate via one or more wired and/or wireless networks 20.

The computing entity 10 may also comprise a user interface device comprising one or more user input/output interfaces (e.g., a display 1516 and/or speaker/speaker driver coupled to a processing device 1508 and a touch screen, keyboard, mouse, and/or microphone coupled to a processing device 1508). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1518 (hard or soft), a touch display, voice/speech or motion interfaces, scanners, readers, or other input device. In embodiments including a keypad 1518, the keypad 1518 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1522 and/or non-volatile storage or memory 1524, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An atomic source device, the device comprising:
a source assembly comprising a source component and deposited atomic source material;
an object storage assembly configured to receive objects emitted by the source assembly and confine them or maintain them within a defined volume; and
a coupling assembly configured to receive objects from the storage assembly and couple them into a confinement region of a confinement apparatus.

2. The device of claim 1, wherein the source component is comprised of a suspended membrane coupled to legs configured to thermally isolate the source component and the deposited atomic source material from at least a portion of the atomic source device.

3. The device of claim 1, wherein the object storage assembly is configured to be reloaded before it becomes empty, such that it stores a constant supply of objects.

4. The device of claim 1, wherein the object storage assembly comprises at least one of a three-dimensional (3D) or a two-dimensional (2D) ion trap.

5. The device of claim 4, wherein the object storage assembly further comprises one or more optical components configured to provide an ionizing beam configured for ionizing objects emitted by the source assembly and received into the defined volume.

6. The device of claim 4, wherein objects emitted by the source assembly are ionized upon emission from the source assembly.

7. The device of claim 1, wherein the source component is configured to heat the deposited atomic source material to cause the objects to be released therefrom.

8. The device of claim 1, wherein the coupling assembly comprises a two-dimensional ion trap.

9. The device of claim 1, wherein the confinement apparatus is a trapped-ion quantum computer.

10. A confinement apparatus assembly comprising:
a confinement apparatus configured to generate at least one confinement regions; and
at least one atomic source device, the at least one atomic source device comprising at least one source assembly comprising a source component and some deposited atomic source material, the at least one atomic source device configured to provide atomic objects from the deposited atomic source material to the at least one confinement region.

11. The confinement apparatus of claim 10, wherein the at least one atomic source device further comprises at least one of:
an object storage assembly configured to receive objects emitted by the source assembly and confine them or maintain them within a defined volume; or
a coupling assembly configured to receive objects provided by the source assembly and couple them into the at least one confinement region.

12. The confinement apparatus of claim 11, wherein radiofrequency (RF) electrodes are configured to generate a tube-shaped potential well, wherein direct current (DC) electrodes are configured to cap ends of the tube-shaped potential, and wherein the DC electrodes are further configured to move atomic objects along the length of the tube-shaped potential.

13. The confinement apparatus of claim 12, wherein the object storage assembly comprises horizontal radiofrequency (RF) electrodes, and wherein the object storage assembly is aligned with the coupling assembly via a taper junction.

14. The confinement apparatus of claim 12, wherein the object storage assembly comprises diagonal RF electrodes, and wherein the object storage assembly is aligned with the coupling assembly via a taper junction.

15. The confinement apparatus of claim 12, wherein the object storage assembly comprises horizontal RF electrodes, and wherein the object storage assembly is aligned with the coupling assembly via butt-coupling.

16. The confinement apparatus of claim 12, wherein the object storage assembly comprises diagonal RF electrodes, and wherein the object storage assembly is aligned with the coupling assembly via butt-coupling.

17. The confinement apparatus of claim 12, wherein the object storage assembly comprises horizontal RF electrodes, and wherein the object storage assembly is aligned with the coupling assembly via a chip-to-chip hurdle.

18. The confinement apparatus of claim 12, wherein the object storage assembly comprises diagonal RF electrodes, and wherein the object storage assembly is aligned with the coupling assembly via a chip-to-chip hurdle.

19. The confinement apparatus of claim 10, wherein at least one atomic source device comprises two or more atomic source devices.

20. The confinement apparatus of claim 19, wherein the two or more atomic source devices comprise source assemblies corresponding to different species of atoms.
